(19) United States
(12) Patent Application Publication
(10) Pub. No.: US 2014/0019575 A1
(43) Pub. Date: Jan. 16, 2014

(54) Maintaining Client-Side Persistent Data using Caching

(71) Applicant: Aubrey S. ALEXANDER, JR., Kent, WA (US)

(72) Inventor: Aubrey S. ALEXANDER, JR., Kent, WA (US)

(21) Appl. No.: 13/546,957

(22) Filed: Jul. 11, 2012

(51) Int. Cl. G06F 15/173; G06F 15/167

(52) U.S. Cl. 709/213; 709/226

(57) ABSTRACT

Non-cookie methods for distinguishing among web-server clients (browsers) use personalized information stored in the browser's cache. The information may be extracted by programs, such as JavaScript programs, executing at the client side; or by sending resource data to cause the client to report the personalized information to the server in conjunction with a resource request.

### CONTINUITY AND CLAIM OF PRIORITY

This is an original U.S. patent application.

### FIELD

The invention relates to user tracking in online services. More specifically, the invention relates to techniques for improving the accuracy of cookie-based tracking schemes.

### BACKGROUND

Those who deliver products or services (or, more generally, information) over the Internet have a strong interest—financially and otherwise—in tracking and analyzing visitors, visits, page views, browsing histories and other characteristics of their customers. For example, a publisher may provide a content site and wish to analyze the reach and frequency of advertising delivered to individual visitors. To do this they should have a reliable and long-lasting way to recognize repeat visitors. Providers of digital products or services primarily use HTTP cookies as a tracking mechanism to determine whether the current visitor is the same visitor that was seen before, or is a new visitor. (HTTP cookies are described in detail in Internet Engineering Task Force (“IETF”) Request for Comments (“RFC”) documents RFC2965, published October 2000.) A publisher's web infrastructure may accumulate a significant amount of interesting information about a visitor over the course of his many page views. This information is tracked and correlated to that visitor by the means of a unique identifier issued to the visitor's computer or web browser. A publisher gets great value from the information it is able to collect about visitors—for example, in estimating user counts, or in selling advertisements to a targeted market, and so on—and thus there is considerable value in being able to build a lasting record of a visitor.

Unfortunately, cookies are easily and often deleted. When this happens, all of the collected information about a visitor may be lost. After cookie deletion, a new cookie will be issued to that visitor on his next visit, and the process of collecting information starts again. The system no longer has any way to know that the current visitor is the same as the previous visitor, because the original cookie was deleted. Any analysis system relying on cookies may mistakenly believe that there are two different visitors (one from before the cookie deletion, and a new visitor after the cookie deletion)—when in fact these are the same visitor. This causes errors in analysis—for example in this case an analytics system would report two unique users, when in fact there was only one. Significantly increased accuracy of analysis would be achieved if the system had alternative means to correlate visitors (i.e., means that could not be thwarted as easily by inadvertent or intentional user action).

### SUMMARY

Embodiments of the invention use the standard data caching mechanisms of an Internet browser to preserve personalized client-identification data. This data can be used to augment a website visitor correlation system and increase its accuracy.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining the operation of an embodiment of the invention.

FIG. 2 is a diagram indicating typical prior-art client-server interactions.

FIG. 3 is a flow chart outlining one way to accomplish a central portion of an embodiment's operations.

FIG. 4 is a flow chart outlining another way to accomplish a central portion of an embodiment's operations.

### DETAILED DESCRIPTION

An embodiment of the invention uses browser resource caching and cache-maintenance operations to store and recover information that can be used to uniquely identify a website visitor. Identity information can be combined with (or used in place of) conventional cookie-based techniques, and may be less susceptible to accidental or intentional clearing by the user.

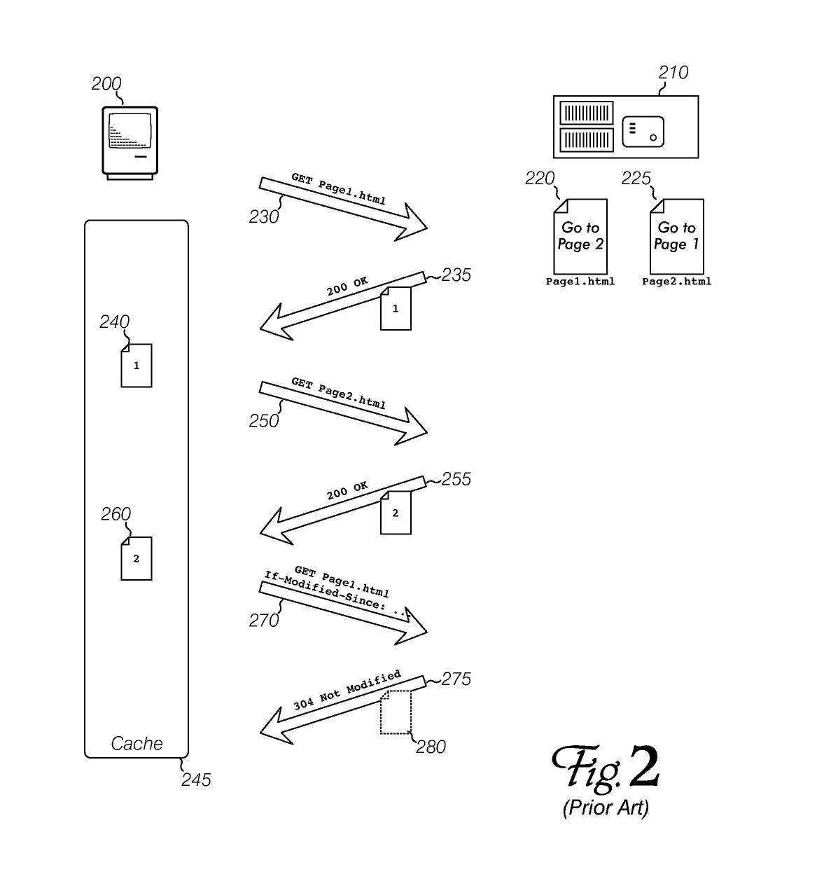

FIG. 2 shows a series of three client-server interactions between a user's personal computer 200 and a server machine 210. (More specifically, web browser software at computer 200 interacts with web server software at computer 210). In this simple example, server 210 makes available two documents, Page1. html 220 and Page2.html 225, each of which contains a hyperlink pointing at the other (i.e., clicking on a link in Page1.html causes a browser to retrieve Page2.html, and vice versa).

Personal computer 200 issues a first request 230 to obtain a copy of Page1.html. This request may be issued in response to the user typing in the appropriate Uniform Resource Locator (“URL”), by clicking a hyperlink in some other document, or after some similar triggering event. This request is an original request, which is specifically defined herein as a request from a client computer to a server computer, when the client computer has never communicated with the server computer before, or when all data associated with any previous communication has been purged from the client computer.

Server 210 transmits response 235, with a “success” status code (“200 OK”) and a copy of the requested document. PC 200 receives the document, stores a copy 240 in the PC's local cache 245, and displays the document to the user. Next, in response to the user's clicking the hyperlink in the displayed document, PC 200 issues a second request 250 to obtain a copy of Page2.html from server 210. The server replies with a second “success” response 255 and a copy of the requested document. Again, PC 200 stores a copy of the document 260 in cache 245 and displays the document.

In the final request/response interaction, PC 200 issues a request 270 to obtain a copy of Page1.html when the user clicks the link in the currently-displayed copy of Page2.html. Request 270 comprises additional information, shown here as an “If-Modified-Since” header. According to the Hypertext Transfer Protocol (“HTTP”), this is one way the client can avoid initiating unnecessary network traffic: by sending information about the copy 240 of the requested resource that is in the client's local cache, it invites the server to respond that the cached copy is up-to-date and need not be re-sent. Response 275 carries such a response code (“304 Not Modified”), and the requested document is not sent (280). The response causes PC 200 to display the saved copy of the document that is in its local cache. Note that this caching is a built-in feature of most browsers, and it works whether the requests for remote resources come from user activity (e.g., clicking a hyperlink, as described here) or from a program request (e.g., a JavaScript program issuing an AJAX call).

Although not shown in FIG. 2 or mentioned in the accompanying description, those of ordinary skill in the relevant arts will understand that the Hypertext Transfer Protocol specification includes session-maintenance features, generally called “cookies,” that permit a server to correlate a series of requests from a particular client. Without such features, it would be much more difficult for a server to determine what requests a client had made, in what sequence and with what result. However, a common first-line technical support suggestion to a user who is having difficulties with a website is to “clear your cookies.” This may fix the user's issue with the website, but it often has the unintended consequence of impairing session tracking at all the other websites the user frequents. The session-rebuilding process for the other websites may result in a degraded experience for the user, and/or it may impair the website provider's service monitoring activities.

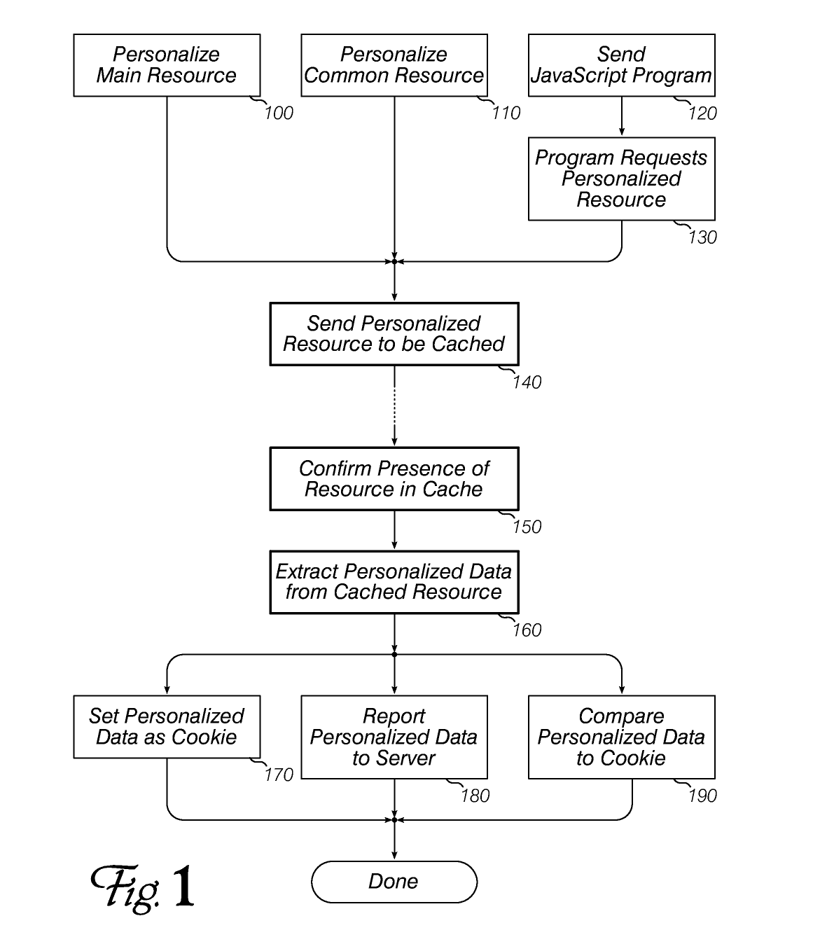

An embodiment of the invention may operate as outlined in the flow chart of FIG. 1 to improve the chance that a server will be able to track a visitor after an original request, despite the occurrence of events like accidental or intentional cookie deletion.

The kernel of an embodiment of the invention comprises the three operations shown near the center of the flow chart: at 140, the server sends a personalized resource to the client, to be cached there. Later, an embodiment confirms that the resource is present in the cache (150) and extracts the personalization data from the resource (160). The personalization data is preferably unique to the client, so it can be used to augment or replace a conventional session-management cookie used for tracking purposes.

Once the personalization data is extracted, it can be used for client session management, just as other prior-art tools can. Since session tracking and session management are typically performed at the server side, most embodiments have some mechanism for transmitting the personalization information to the server. For example, a JavaScript® program at the client may set the personalization data as a cookie (170) or transmit the personalization data to the server with a request (180). Or, at the client side, the program might compare the personalization data to a standard cookie to detect cookie tampering or deletion and assignment of a new cookie (190).

An embodiment can arrange to send the personalized resource to the client in several different ways. A simple way is to personalize the main resource of the site (e.g., the home page) before sending it (100). Another way is to personalize a resource that appears on many or all pages, such as a logo image, header or footer (110). Yet another way is to send a JavaScript® program (120) that causes the browser to issue a request for the personalized resource (130). Suitable resources to be personalized and methods for performing the personalization are discussed below. However, note that the amount of information required for effective personalization is quite small: even 32 bits of information embedded into the cached resource can be used to distinguish between billions of different clients. A preferred way to use the personalization data is as a (cryptographic) nonce: an arbitrary value whose principal purpose is to correlate or link other pieces of information that should be associated with the client that has the nonce. For example, the nonce could be used as a key to a plurality of records in a database, where the records contain the information about the activities and interactions with the website of the client to which the nonce was issued.

Returning to the central operations of an embodiment of the invention, it is recognized that confirming the presence of a resource in a cache (150) and extracting information from the cached copy of the resource (160) can be challenging in the context of standard HTTP client/server operations. (For security reasons, client-side programs, such as JavaScript programs, may not be permitted to examine the cache directly, and of course the server has no direct access to the client's cache either.) However, at least two practical methods of accomplishing these tasks exist and are described here.

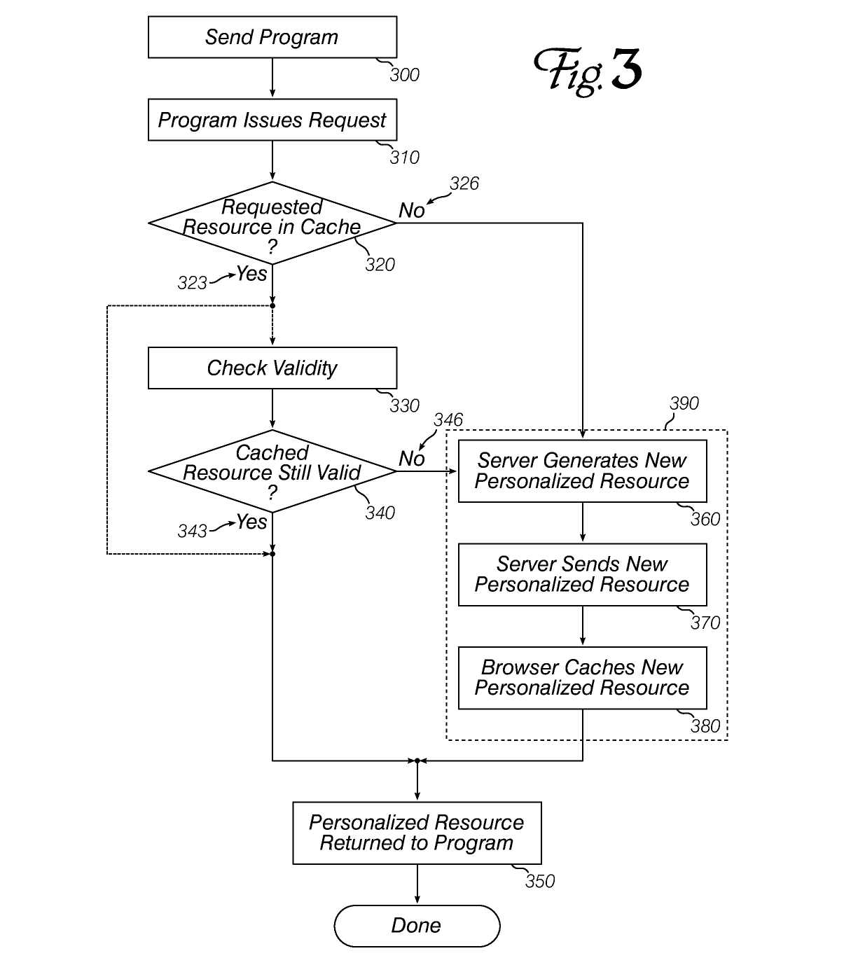

The first method, outlined in FIG. 3, is to send a program for execution at the client browser (300). This may be, for example, a JavaScript program or function, and may be included among other functions transmitted to the client to implement various website functions. When the browser executes the program or function, the executable code issues a request for the personalized resource (310). (The request may be directed to the server from which the program was received, or to a different server.) The request is processed initially by the browser software at the client computer, which checks to see whether the requested resource is in the browser's cache (320). If it is (323), the resource may be returned to the JavaScript function immediately (350); or the browser may send a network request to the server to confirm that the cached resource is still valid (330). If it is (343) (or if the check is skipped), then the browser delivers the personalized resource from its cache to the JavaScript program (350), and the program can extract the personalized data. If the resource is not in the browser's cache (326) or the server responds that the cached resource is no longer valid (346), then a new personalized resource will be generated at the server (360), sent to the client (370), cached in the browser's cache (380), and delivered to the requesting JavaScript program (350). (The sequence of events 390 corresponds to a browser's original request for the personalized resource, when there is no cached resource, or the cache is outdated.)

Note that the JavaScript program cannot control (and may be unable to determine) whether its request for the personalized resource was satisfied from the browser's cache or by delivery of a new personalized resource from the server. However, if the personalization data includes a timestamp or other serialization indicator, the program can figure out whether the resource is likely to be old or new. And, in any case, the program can report the personalization data it obtains back to the server, and the server can tell definitively when it issued that data.

It is appreciated that the JavaScript program's request for a resource may refer to an item that has already been loaded by the browser during its processing of other data. For example, if the personalized resource is a logo or other image to be displayed on the page, the HTML of the page may list it in an IMG (image) tag, and the browser may retrieve and cache it in the normal course of its operations. The JavaScript function may request (another copy of) the same image, and its request is likely to be satisfied from the browser's cache.

It is important to keep in mind that the personalization (i.e., the portion of the personalized resource that is unique to a client) is located within the resource's data (or, as will be discussed below, within metadata associated with the resource). The name (or Uniform Resource Locator, “URL”) by which clients request the personalized resource is the same for every client. In other words, a first client that requests “http://www.example.com/EmbodimentResource.jpg” will receive (and cache) different data than a second client that requests the resource of the same name. The differences in the data will include the personalization information.

Once the JavaScript program obtains the personalized resource, it can process the resource's data to extract the personalization information, and then set the information as a (an additional) cookie (recall FIG. 1, 170); transmit the information to the server (FIG. 1, 180), or perform further client-side checks to detect cookie tampering or cache clearing (FIG. 1, 190). If the information is transmitted to the server, the browser software may also include a traditional HTTP cookie, so the server will have both the cookie and the personalization information of an embodiment, so that it can correlate the two sessions and perhaps link the current session with earlier recorded session data.

In some embodiments, the JavaScript program may store the personalization information locally, using an alternate storage facility such as the LocalStorage library. In some environments, the JavaScript program may use the Canvas feature of the browser to create a new image (or modify an existing image) to contain the personalization information. When the browser saves this programmatically-created image, it may provide another “backup” location to help prevent loss of the personalization information. (It should be understood that references to JavaScript as the language in which a program is implemented, are merely indicative of one of many possible programming languages that may be used to implement the inventive features.)

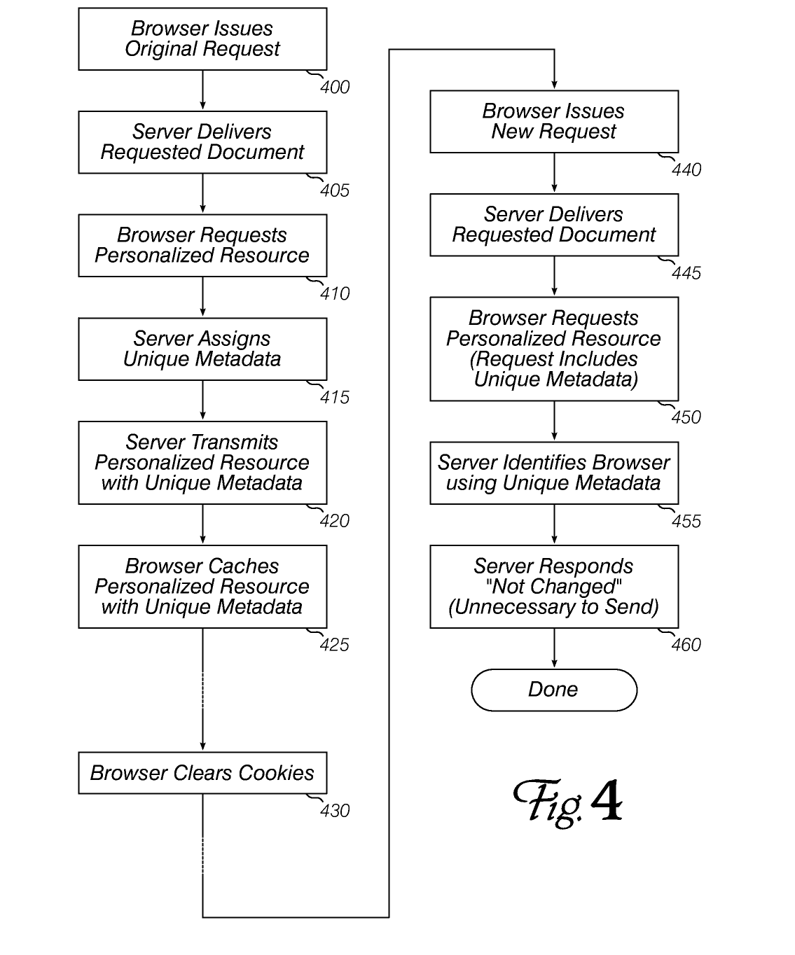

In the embodiment described with reference to FIG. 3, knowledge of the personalization information is developed or produced through operations of an executable program running at the client's location. Once the personalization information is extracted, it can be transmitted back to the server for further processing, but the embodiment relies on the ability to execute instructions at the client. In some situations, this ability is constrained or even absent. Fortunately, there is a second method by which an embodiment can cause personalization information can be stored in a client browser's cache, and reported back to the server for use in session tracking. FIG. 4 outlines this method for accomplishing the “confirming” and “extracting” operations (150, 160) of an embodiment.

FIG. 4 outlines a subtle method that does not require any special cooperation from the client or execution of a server-provided program, so it may be more broadly applicable. In this embodiment, the personalization data is not embedded in the resource itself, but rather is encoded into metadata associated with the resource. The resource itself may be bit-for-bit identical among all clients, and each client may reference it by the same name.

The example interaction sequence discussed here will begin with an original request (i.e., this browser has never communicated with the server before, or all data relating to such earlier communications has been purged from the user's computer). The browser issues an original request for a document (400). For example, the browser may have been directed to retrieve the home page of a website. The server delivers the requested document (405), which contains a reference to a resource that will serve as the “personalized” resource in this embodiment. For example, the document may include a link to cause the browser to load a Cascading Style Sheet (“CSS”) formatting aid, or an image to be displayed on the main page.

Next, the browser issues a request for the personalized resource (410). When the browser requests this resource, it does not send an “If-Modified-Since” or “If-None-Match” header, because this is an original request sequence, and the browser does not yet have a copy of the resource in its cache. Before the server sends the resource, it personalizes it by assigning unique metadata (415). For example, although the computer file containing the resource may have been last modified on Mar. 6, 2012, the server may assign a different (and therefore false), unique date to the resource, and transmit the false date to the client as the Last-Modified date. Alternatively, the server can assign an arbitrary, unique Entity Tag (“ETag”) and transmit it to the client. The browser will use the metadata to help manage its cache and to avoid superfluous data transfer.

The server transmits the “personalized” resource (420) and the browser caches it, associating it with the unique, personalized metadata (425). The server may also attempt to use traditional cookies to identify the user, and the browser may or may not accept them. The user may continue to interact with the server, even over multiple sessions, but eventually, he directs the browser to clear its cookies (430).

The next time the browser requests a document from the server (440), the server returns it (445). Like the very first document retrieved at 400-405, this document also includes a link or other reference to the personalized resource. However, in contrast to the browser's request 410, its next request (450) for the personalized resource comprises the unique metadata assigned by the server at 415 and stored with the browser's cache at 425. For example, the browser may send an “If-Modified-Since” header, thereby providing to the server the false “Last Modified” date earlier assigned by the server.

The server can use the unique metadata to identify the client (455), despite the fact that its cookies have been cleared from the browser's “cookie jar” (at 430). The server may reply with a 304-class response, indicating that the browser's cached resource is still valid and the data need not be retransmitted (460).

Through this sequence (and particularly steps 450-460), the server has learned 1) that the client has cached the personalized resource, and 2) what the personalization nonce is (in this example sequence, the nonce is the false “Last Modified” date or the Entity Tag). As in other embodiments, the server can attempt to set an HTTP cookie, record the nonce and client activity for future use, and/or detect that the client has deleted or tampered with an earlier-issued HTTP cookie. The foregoing operations of an embodiment may happen in parallel with traditional HTTP cookie-based session management, so the server may have both the cookie and the inventive personalization data for the same client. Thus, the client's subsequent activity can be correlated with activity recorded earlier with a different cookie, but the same personalization data. The server may also have the inventive personalization data for two or more different sessions, allowing the server to correlate two or more sessions using pluralities of the inventive personalization data recorded during different sessions.

As noted earlier, only a small amount of data need be encoded into a personalized resource (and indeed, as explained in reference to FIG. 4, the nonce may even be encoded into metadata that is merely associated with the personalized resource). It is preferred that the personalization of a resource not be readily apparent to the user. In one embodiment, the personalized resource is a graphic image, and the personalization data is encoded into low-order bits of predetermined pixels. (This is essentially a steganographic technique.) An image modified in this way may be visually indistinguishable from an unmodified image (or from an image personalized for someone else). In fact, even a single-pixel image may be able to encode a useful amount of personalization data inconspicuously, so common “web bug” techniques may be adapted to work with an embodiment. JavaScript programs can examine image (binary) data directly, or use a recently-developed HTML5 feature called “Canvas” to get simpler access to individual pixel values.

Another type of resource that may be personalized with embedded data is a Cascading Style Sheet, which provides information about fonts, colors, backgrounds, position and so on to enable the browser to render a page as intended by the designer. A personalized CSS document may provide formatting information for non-existent element types, so there would be no visual evidence of the use of this embodiment. A client-side JavaScript program would nonetheless be able to examine the personalized image or style sheet and extract the personalization data. In fact, a JavaScript program can itself be personalized with embedded data, since the browser's caching mechanism also applies to such programs. In this case, “examining” and “extracting” the data would just be executing the program. Listing 1 shows a portion of a personalized JavaScript program:

Listing 1

10 // ...preceding JavaScript code...
20 var PersonalizationData = ’Unique To Client’;
30 sendToServer( PersonalizationData );
40 // ...other JavaScript code...

This program code would be retrieved by each client using the same URL or file name, but the server would replace the ‘Unique To Client’ string in line 20 with different text for each client. The subsequent sendToServer( ) function call in line 30 would cause the client to report the unique information to the server, along with any HTTP cookies allocated to the client. It is understood that the ‘JavaScript program’ here could be any type of executable code that could be run on the client.

In an embodiment that uses metadata modification, the “seconds” or even “microseconds” value of a date or timestamp can be manipulated to distinguish between millions of clients, with no other practical harm to the client-server interaction (it is exceedingly unlikely to matter whether an image file or other resource was last modified on 6 Jun. 2012 at 12:34:56.987654 or 6 Jun. 2012 at 12:34:56.987653, yet that single microsecond difference may be adequate to distinguish two different clients.)

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that browser identity correlation can also be produced by software and hardware that distribute the functions of embodiments of this invention differently than herein described. Such variations and implementations are understood to be captured according to the following claims.

I claim:

1. A method comprising:
transmitting a personalized resource to be cached by a browser;
confirming that the personalized resource is stored in a cache of the browser; and
extracting personalization data from the personalized resource.

2. The method of claim 1, further comprising:
setting the personalization data as a session identifier.

3. The method of claim 1, further comprising:
reporting the personalization data from the browser to a server.

4. The method of claim 3, further comprising:
correlating a first session identifier and a second, different session identifier with each other using the personalization data.

5. The method of claim 1, further comprising:
comparing the personalization data to a session identifier.

6. The method of claim 1 wherein the personalized resource is a main resource of a website.

7. The method of claim 1 wherein the personalized resource is a common resource of a website.

8. The method of claim 1 wherein the personalized resource is an image.

9. The method of claim 1, further comprising:
transmitting an executable program to the browser, the executable program to cause the browser to perform operations comprising:
requesting the personalized resource.

10. The method of claim 1 wherein the personalized resource contains a unique nonce encoded into inconspicuous bits of an image.

11. The method of claim 1 wherein the personalized resource contains a unique nonce encoded into an entry of a Cascading Style Sheet.

12. The method of claim 1 wherein the personalized resource contains a unique nonce encoded into a portion of a Javascript program

13. The method of claim 1 wherein the personalized resource contains a unique nonce encoded into a program that can execute on the browser.

14. The method of claim 1 wherein the personalized resource contains a unique nonce encoded as a modification date of the personalized resource.

15. The method of claim 1 wherein the personalized resource contains a unique nonce encoded as an entity tag of the personalized resource.

16. A method comprising:
receiving a first original request from a first client, the first original request to obtain a resource;
altering the resource to produce a first personalized resource and sending the first personalized resource to the first client;
receiving a second original request from a second client, the second original request to obtain the resource;
altering the resource to produce a second personalized resource, different from the first personalized resource, and sending the second personalized resource to the second client.

17. The method of claim 16 wherein sending a personalized resource to a client comprises sending information to cause the client to cache the personalized resource.

18. The method of claim 16, further comprising:
allocating a first session key to identify the first client;
sending the first session key to the first client; and
storing information to associate the first session key with the first personalized resource.

19. The method of claim 16 wherein altering the resource to produce a personalized resource comprises:
selecting a false modification date to be sent with the personalized resource.

20. The method of claim 16 wherein altering the resource to produce a personalized resource comprises:
encoding personalization information into a predetermined subset of bits of the resource.

21. The method of claim 20 wherein the resource is a graphical image.

22. The method of claim 20 wherein the resource is a Cascading Style Sheet (“CSS”) document.

23. The method of claim 20 wherein the resource is a JavaScript program.

24. The method of claim 20 wherein the resource is a program that can execute on the client.

25. A method comprising:
transmitting executable instructions to a computer, the executable instructions to cause the computer to perform operations comprising:
a) issuing a request for a predetermined resource;
b) extracting personalization information from the predetermined resource; and
c) reporting the personalization information;
receiving a request for a resource, the request including a caching indicator but lacking a session key;
transmitting a resource-not-modified response to the request;
receiving personalization information from the computer;
correlating the personalization information with a previously-allocated session key; and
transmitting the previously-allocated session key to the computer.
